(19) United States
(12) Patent Application Publication
(10) Pub. No.: US 2026/0227583 A1
(43) Pub. Date: Aug. 6, 2026

(54) TRANSCEIVER INSERTION EXTRACTION TOOL

(71) Applicant: Hubbell Incorporated, Shelton, CT (US)

(72) Inventors: Tadeusz Zagula, Newington, CT (US); Brian Bourgoin, East Haddam, CT (US)

(21) Appl. No.: 19/152,571

(22) PCT Filed: Jan. 30, 2024
(86) PCT No.: PCT/US2024/013478

§ 371 Date: Jul. 31, 2025

Related U.S. Application Data
(60) Provisional application No. 63/442,225, filed on Jan. 31, 2023.

(51) Int. Cl. G02B 6/38; B25B 7/08; B25B 9/02

(52) U.S. Cl. CPC G02B 6/3898; B25B 7/08; B25B 9/02

(57) ABSTRACT

A tool includes a U-shaped body having an integral one-piece construction. The body includes a first end having a first rounded undercut disposed on an inner surface of the body, a second end having a second rounded undercut disposed on the inner surface of the body and arranged facing the first undercut, and a hinge portion disposed between the first end and the second end. The body can move in a first direction about the hinge portion between a neutral position where the first and second ends are spaced apart from one another and a biased position where the first and second ends are in contact with one another. In the biased position, the first rounded undercut and the second rounded undercut form an enclosed perimeter configured to capture and secure at least a portion of the transceiver.

### CROSS-REFERENCE TO RELATED APPLICATION

This application claims the benefit of U.S. Provisional Application No. 63/442,225, filed Jan. 31, 2023, the entire contents of which is incorporated herein by reference in its entirety.

### FIELD

The present disclosure relates to a manual tool. More particularly, the present disclosure relates to an extraction tool for removing transceivers from control panels and/or inserting transceivers into control panels.

### BACKGROUND

Fiber optic cables contain one or more optical fibers that transmit signal using light. Fiber optic cables are typically used in telecommunication applications and/or long-distance data transmission.

Fiber optic cables are connected to a control panel that can send or receive optical data through the optical fibers. The control panels may be located in a server room or data center.

In some examples, each fiber optic cable may be indirectly connected to the control panel. A transceiver may be located between each cable and the control panel. The transceiver may therefore be directly connected or plugged into a receptacle on the control panel, and a fiber optic cable may be connected to an end of the transceiver at least partially exposed from the control panel. The transceivers are used to regulate optical data into and out of the control point in the control panel.

In order to save space, multiple fiber optic cables may be connected to the same control panel and multiple control panels may be stored close together. For example, each control panel may include multiple receptacles, each of which can receive a transceiver. Multiple control panels may all be stored together in a housing. Although this configuration may conserve space within the data center, the high density of cables may make accessing an individual cable and/or transceiver challenging. The cables and the transceivers need to be removed by technicians from time to time to facilitate inspection. However, when removing one transceiver, the technician does not want to accidently remove an adjacent transceiver.

Because the cables are closely packed together, it is challenging for technicians to remove the transceivers by hand and they typically use a tool to facilitate removal. These tools, which can include generic plyers or tweezers, are typically ineffective at accurately and efficiently removing a single transceiver from a control panel containing multiple other transceivers and cables. For example, transceivers may include a latch (e.g., a bail clasp) that helps to secure the transceiver within the control panel. To remove the transceiver, the technician needs to move the latch to the unlocked position so that the transceiver can translate relative to the control panel. Although generic plyers and tweezers could be used to grab the latch, neither is purpose built for the application of removing the transceiver. The flat, elongated shape of a generic tool does not provide a sufficient gripping force to the generally curved latch, particularly when the technician needs to maneuver the tool between other cables and transceivers still plugged into the control panel. As a result, technicians may frequently drop the transceivers during the inspection process, potentially damaging them.

Additionally, reconnecting the transceiver to the control panel may be similarly difficult using the generic tool. To insert the transceiver into the control panel, the transceiver needs to be positioned into the receptacle and the latch needs to be moved to the locked position. Neither the transceiver nor the latch provides a location to adequately grasp the transceiver with the tool to both prevent dropping the transceiver and to maneuver the transceiver between the other cables.

### SUMMARY

Various examples of the present disclosure can overcome various disadvantages associated with known generic tools used to insert and remove a transceiver and offer new advantages as well.

According to one aspect of various examples of the present disclosure there is provided a tool or inserting and/or removing an electrical device from a socket.

According to one aspect of various examples of the present disclosure there is provided a tool for removing a transceiver from a control panel.

According to one aspect of various examples of the present disclosure there is provided a tool for inserting a transceiver into a control panel.

According to another aspect of various examples of the present disclosure, there is provided a tool for grasping and capturing a portion of a transceiver.

According to another aspect of various examples of the present disclosure, there is provided a tool having a first end with a first undercut and a second end with a second undercut, wherein the first and second ends contact one another in a closed position so that the first undercut and the second undercut combine to form an enclosed perimeter.

According to another aspect of various examples of the present disclosure, there is provided a tool for facilitating the insertion or removal of a transceiver relative to a control panel. The tool includes an arcuate body having an integral one-piece construction. The body includes a first end having a first rounded undercut disposed on an inner surface of the body, a second end having a second rounded undercut disposed on the inner surface of the body and arranged facing the first undercut, and a hinge portion disposed between the first end and the second end.

According to another aspect of various examples of the present disclosure, there is provided a tool for facilitating the insertion or removal of a transceiver relative to a control panel. The tool includes a U-shaped body having an integral one-piece construction. The body includes a first end having a first rounded undercut disposed on an inner surface of the body, a second end having a second rounded undercut disposed on the inner surface of the body and arranged facing the first undercut, and a hinge portion disposed between the first end and the second end.

According to another aspect of various examples of the present disclosure, there is provided a tool for facilitating the insertion or removal of a transceiver relative to a control panel. The tool includes a U-shaped body having an integral one-piece construction. The body includes a first end having a first rounded undercut disposed on an inner surface of the body, a second end having a second rounded undercut disposed on the inner surface of the body and arranged facing the first undercut, and a hinge portion disposed between the first end and the second end. The body also includes first guide portion disposed on the inner surface of the body between the first end and the hinge portion, and a second guide portion disposed on the inner surface of the body between the second end and the hinge portion. The second guide is offset from the first guide. The body can move in a first direction about the hinge portion between a neutral position where the first and second ends are spaced apart from one another and a biased position where the first and second ends are in contact with one another. The first guide portion and the second guide portion can limit movement in a second direction about the hinge portion that is perpendicular to the first direction. In the biased position, the first rounded undercut and the second rounded undercut form an enclosed perimeter configured to capture and secure at least a portion of the transceiver.

According to another aspect of various examples of the present disclosure, there is provided a tool for facilitating the insertion or removal of a transceiver relative to a control panel. The tool includes a U-shaped body with a first end having a first undercut disposed on an inner surface of the body, a second end, and a hinge portion disposed between the first end and the second end. The body also includes a first grip feature disposed between the first end and the hinge portion. The first grip feature includes a different surface texture than the surrounding portion of the body. The body can move about the hinge between a neutral position where the first and second ends are spaced apart from one another and a biased position where the first and second ends are in contact with one another. In the biased position, the first undercut and the second end form an enclosed perimeter that is configured to capture and secure at least a portion of the transceiver.

According to another aspect of various examples of the present disclosure, there is provided a tool for facilitating the insertion or removal of a transceiver relative to a control panel. The tool includes a U-shaped body with a first end having a first undercut disposed on an inner surface of the body, a second end, and a hinge portion disposed between the first end and the second end. The body includes a biasing member disposed between the first end and the second end and spaced apart from the hinge portion. The body can move about the hinge between a neutral position where the first and second ends are spaced apart from one another and a biased position where the first and second ends are in contact with one another. In the biased position, the first undercut and the second end form an enclosed perimeter that is configured to capture and secure at least a portion of the transceiver.

According to another aspect of various examples of the present disclosure, there is provided a method for removing a transceiver from a control panel that includes grasping a transceiver latch with a purpose-built tool that can at least partially enclose the latch.

According to another aspect of various examples of the present disclosure, there is provided a method for removing a transceiver from a control panel that includes removing a cable from a first end of a transceiver received within a receptacle of the control pane, the first end including a latch; positioning a tool at least partially around the latch, the tool comprising: a U-shaped body comprising, a first end having a first undercut disposed on an inner surface of the body, a second end having a first undercut disposed on an inner surface of the body, a hinge portion disposed between the first end and the second end; and applying a force to the body to move the body from a neutral position toward a biased position, wherein a spacing between the first end and the second end is less in the biased position than in the neutral position; partially surrounding a portion of the latch with the first undercut; pulling the tool to move the latch from a locked position to an unlocked position, wherein the portion of the latch remains partially surrounded by the first undercut; and applying an additional force to move the second end into contact with the first end, wherein the first undercut and the second undercut forming an enclosed perimeter to capture the portion of the latch.

According to another aspect of various examples of the present disclosure, there is provided a method for inserting a transceiver from a control panel that includes moving a latch on a first end of a transceiver from an unlocked to a locked position; positioning a tool at least partially around the latch, the tool comprising: a U-shaped body comprising, a first end having a first undercut disposed on an inner surface of the body, a second end having a first undercut disposed on an inner surface of the body, a hinge portion disposed between the first end and the second end; and applying a force to the body to move the body from a neutral position toward a biased position, wherein a spacing between the first end and the second end is less in the biased position than in the neutral position; partially surrounding a portion of the latch with the first undercut; inserting a second end of the transceiver into a receptacle of the control panel.

According to another aspect of various examples of the present disclosure, there is provided a method for inserting a transceiver from a control panel, the method including: moving a latch at a first end of the transceiver to a locked position; positioning a tool at least partially around the latch, the tool including: a U-shaped body including, a first end having a first undercut disposed on an inner surface of the body, a second end, a hinge portion disposed between the first end and the second end, and applying a force to the body to move the body from a neutral position toward a biased position, wherein a spacing between the first end and the second end is less in the biased position than in the neutral position; partially surrounding a portion of the latch with the first undercut; and pushing the tool to move the transceiver into a receptacle of the control panel.

The disclosure herein should become evident to a person of ordinary skill in the art given the following enabling description and drawings. The drawings are for illustration purposes only and are not drawn to scale unless otherwise indicated. The drawings are not intended to limit the scope of the disclosure. The following enabling disclosure is directed to one of ordinary skill in the art and presupposes that those aspects within the ability of the ordinarily skilled artisan are understood and appreciated.

### BRIEF DESCRIPTION OF THE DRAWINGS

Various aspects and advantageous features of the present disclosure will become more apparent to those of ordinary skill when described in the detailed description of preferred examples and reference to the accompany drawing wherein:

FIG. 1 is a perspective view of a plurality of cables and a plurality of transceivers connected to a control panel.

FIG. 2 is a cable being connected to a transceiver received within the control panel of FIG. 1.

FIG. 3 is a perspective view of a control panel illustrating a plurality of receptacles.

FIG. 4 is a rear view of the control panel of FIG. 3.

FIG. 5 is a perspective view of a transceiver usable with the control panel illustrating a latch in the locked position.

FIG. 6 is a perspective view of the transceiver of FIG. 5, illustrating the latch in the unlocked position.

FIG. 7 is a perspective view of a tool used to insert and remove the transceiver of FIG. 5 from a control panel.

FIG. 8 is a side view of the tool of FIG. 7.

FIG. 9 is a cross-sectional view of the tool of FIG. 7 illustrating tool guides.

FIG. 10 is a side view of the tool of FIG. 7 moved to a biased position.

FIG. 11 is a perspective view of the transceiver of FIG. 5 inserted into a receptacle of the control panel of FIG. 3.

FIG. 12 is a perspective view of the tool of FIG. 7 grasping the transceiver while received within the receptacle.

FIG. 13 is a detail view of the tool of FIG. 7 moving the latch of the transceiver to an unlocked position.

FIG. 14 is a detail view of the tool of FIG. 7 grasping the latch of the transceiver while in the unlocked position.

FIG. 15 is a detail view of the tool of FIG. 7 moving the transceiver out of the receptacle of the control panel.

FIG. 16 is a perspective view of the tool of FIG. 7 moving the transceiver into the receptacle of the control panel.

FIG. 17 is a perspective view of the tool of FIG. 7 securing the transceiver within the receptacle of the control panel.

FIG. 18 is a perspective view of an alternate example of a tool.

### DETAILED DESCRIPTION

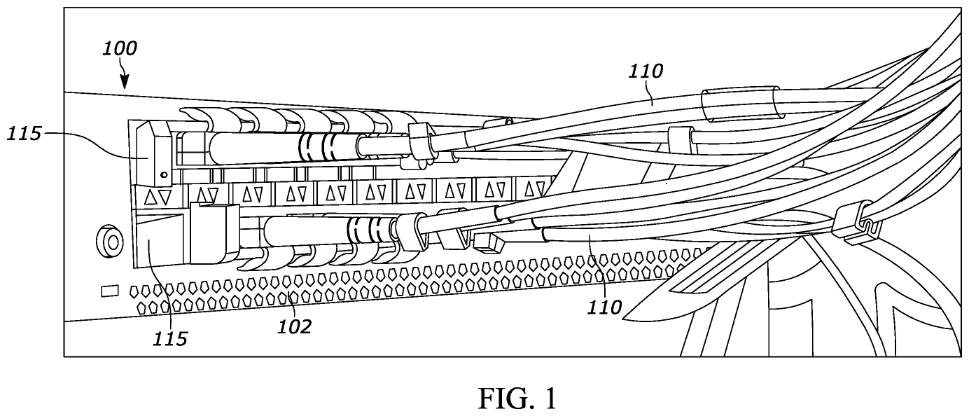

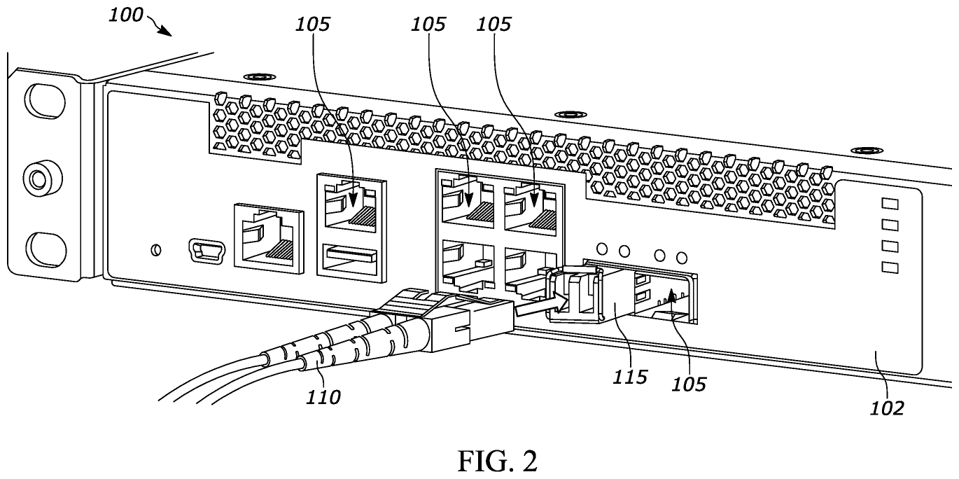

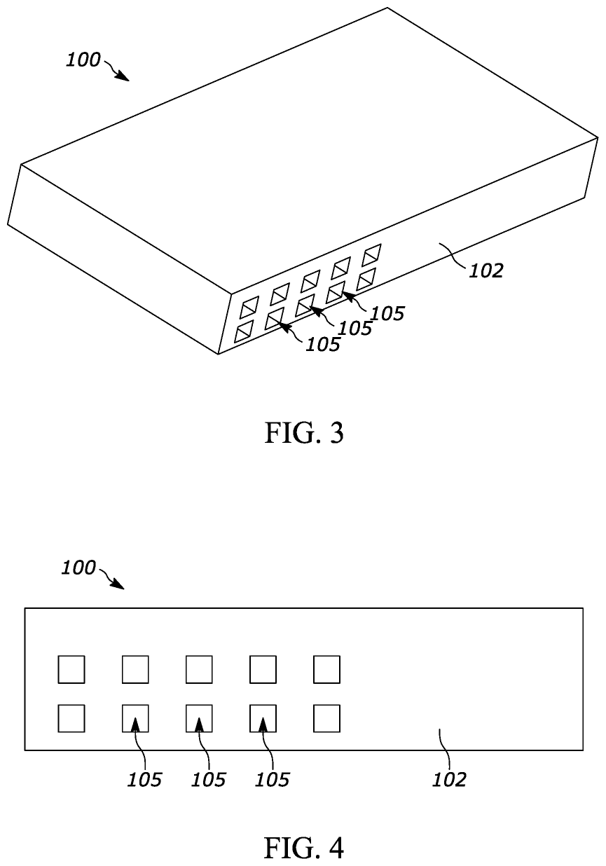

FIGS. 1 and 2 illustrate a control panel 100 that can be used in telecommunications or other similar applications. The control panel 100 may be housed together with other control panels 100 within a server room. Each control panel 100 may include at least one receptacle 105 (see e.g., FIG. 2). Generally, each control panel 100 includes a plurality of receptacles 105 (e.g., ten receptacles in the control panel 100 of FIG. 3). Any number of receptacles 105 may be included in the control panel 100, and the function of each receptacle 105 may or may not be the same as the other receptacles.

As illustrated in FIG. 1, at least one cable 110 may be connected to the control panel 100. Generally, one cable 110 is connected to the control panel 100 through one of the individual receptacles 105, although multiple cables 110 could be connected to the same receptacle 105. The cables 110 connected to a single control panel 100 may become tangled with one another. Storing multiple control panels 100 together positions more cables 110 together, which may lead to more cables 110 being tangled.

As illustrated in FIG. 2, a cable 110 may not be inserted directly into the receptacle 105. A transceiver 115 may be inserted at least partially into one of the receptacles 105, and a cable 110 may connect to the transceiver 115. Generally, a single cable 110 may connect to a single transceiver 115, although in other examples, multiple cables 110 may connect to a single transceiver 115.

As shown in FIGS. 3 and 4, a control panel 100 may include a plurality of receptacles 105 (e.g., ten, although any number may be included). The receptacles 105 may be positioned on a single surface (e.g., the rear surface 102) and may be closely positioned together. For example, all the receptacles 105 may be closely positioned together on only a portion of the rear surface 102. Although in other examples, the receptacles 105 may be more spread out and/or more dispersed across the rear surface 105 (or other surfaces of the control panel 100).

In some forms, each of the receptacles 105 may have substantially the same shape. The illustrated example shows a generally rectangular shape, although other shapes (e.g., circular, elliptical, triangular, etc.) may also be used. Additionally, one or more of the receptacles 105 may have different shapes from one another.

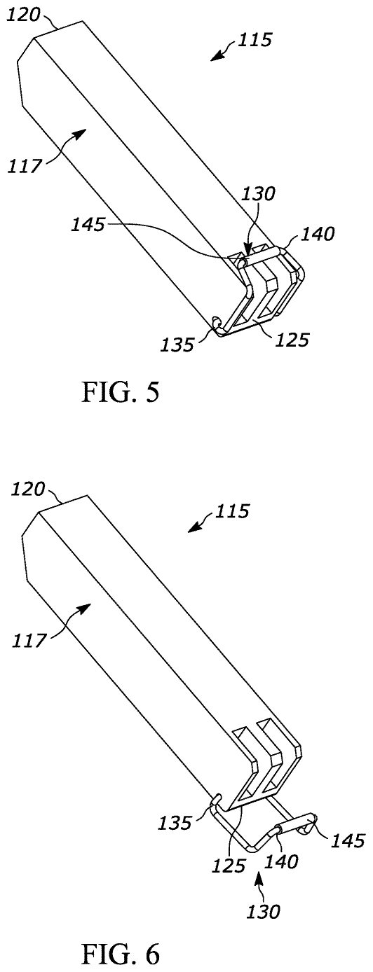

FIGS. 5 and 6 illustrate one example of a transceiver 115. The transceiver 115 includes a generally rectangular shape, although any shape may be used. Specifically, the shape of the transceiver 115 generally corresponds to the shape of the receptacle 105 so that the transceiver 115 can be received within the receptacle 105.

The transceiver 115 includes a body 117 with a first end 120 and a second end 125 opposite to the first end 120. As described in more detail below, the first end 120 is removable insertable into one of the receptacles 105. Inserting the transceiver 115 may form an electrical and mechanical connection with the control panel 100. The transceiver 115 may be only partially received within the receptacle 105 (e.g., the length of the transceiver 115 exceeds the length of the receptacle 105) so that the second end 125 extends at least partially out of the receptacle 105.

The second end 125 of the transceiver 115 includes a latch 130, which may be used to assist in retaining the transceiver 115 within on the receptacles 105. The illustrated latch 130 is a bail clasp, although any type of latch 130 may be used. The bail clasp 130 may be pivotably connected to the body 125 and movable between a locked and an unlocked position. Other types of latches 130 may be move in different ways, like only translating or translating and pivoting.

The latch 130 includes a pair of end portions 135 (only one shown) and a central portion 140. The end portions 135 are connected to sides of the body 117 and enable pivoting motion between the latch 130 and the body 117. In other examples, a piece of material may connect the two end portions 135 together through the body 117.

The central portion 140 may extend at least partially along the outer surface of the body 117 between the pair of end portions 135. The central portion 140 may optionally include a sleeve 145 to increase the diameter of the central portion 140.

FIG. 5 illustrates the latch 130 in the locked position, where the central portion 140 is positioned proximate to (e.g., in contact with) the body 117. For example, sections of the latch 130 proximate to the end portions 135 may be substantially perpendicular to an axis of the body 117 extending between the first and second ends 120, 125. The central portion 140 may contact a top surface 150 of the body 117 (e.g., via the sleeve 145) in the locked position. This may assist in enabling a cable 110 to connect to the transceiver 100, as well as providing a smaller footprint for the transceiver 115.

FIG. 6 illustrates the latch 130 in an unlocked position, where the central portion 140 is positioned distal to the body 117. In the illustrated example, the latch 130 may be pivoted approximately 90° away from the body 117, although in other example, the latch 130 may be pivoted any other angle (e.g., about 30°, about 45°, about 60°, about 105°, etc.). In this position, the sections of the latch 130 proximate to the end portions 135 may be substantially parallel to the axis of the body 117 extending between the first and second ends 120, 125. The central portion 140 may be spaced apart from the second end 125 of the body 117, which as described in more detail below, may make it easier to be grasped by a technician.

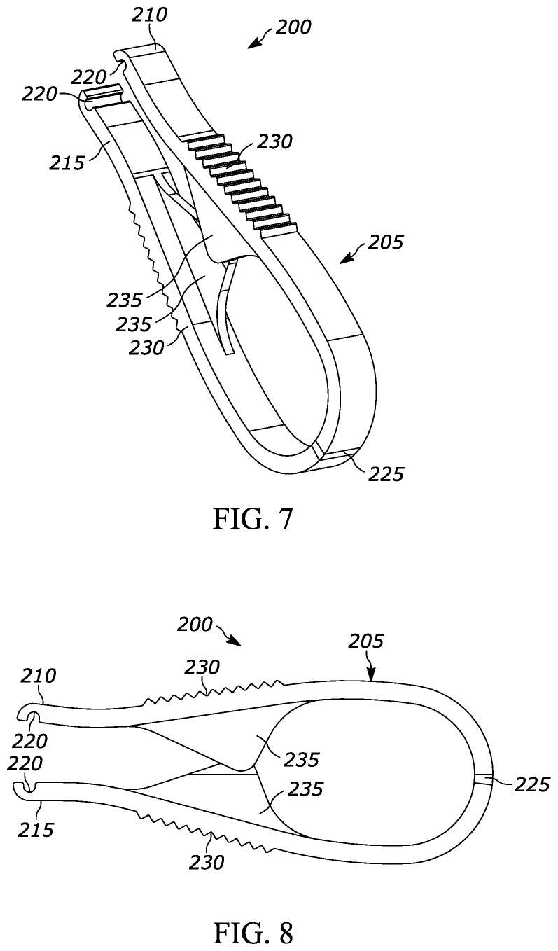

FIGS. 7 to 10 illustrate a tool 200 that is usable with the transceiver 100 to facilitate removal and insertion from the receptacle 105 of the control panel 115. The tool 200 is integrally constructed as a single piece, although other examples of the tool 200 may be multiple pieces.

The tool 200 may include a body 205 with a first end 210 and a second end 215 that together make up a working end of the tool 200. The body 205 may connect the first and second ends 210, 215 together via the one-piece construction.

In the illustrated example, the first end 210 and the second end 215 each include a cutout 220. Each cutout 220 may be disposed on an inner surface of the body 205 (e.g., an undercut) so that both cutouts 220 are arranged in a facing relationship with one another. Each cutout 220 may have a substantially semi-circular cross section that is similar to the shape of the central portion 140 of the latch 130. In other examples, the cross-sectional shape of one or more of the cutouts 220 may be different (e.g., semi-elliptical, triangular, rectangular, etc.). These alternate shapes may similarly correspond to the shape of the central portion 140 of the latch 130 (e.g., the width and/or height of the cutout 220 may be larger than the width of the central portion 140).

In other examples, only one of the first end 210 and the second end 215 may include a cutout 220. For example, the single cutout 220 may be deeper (e.g., include a greater volume) so that the combined volume of the first and second ends 210, 215 remains approximately the same. In other words, the width and the height of the cutout 220 may be larger than the width and the height of the central portion 140.

The body 205 of the tool 200 also includes a hinge 225, which may be positioned in a center of the body 205 distal to either end 210, 215. The illustrated hinge 225 is not a separate element because the body 205 is formed in one piece. Instead, the hinge 225 may be a location about which the body 205 can flex or pivot and may or may not be visually distinctive from the surrounding regions of the body 205. As will be described in more detail below, pressure can be applied to the body 205 to produce a flexing or pivoting motion so that the spacing between the first and second ends 210, 215 changes.

The body 205 may also include at least one grip 230 (e.g., a pair of grips 230 are shown). The grips 230 may be disposed between one of the respective ends 210, 215 and the hinge 225 on an outer surface of the body 205. The illustrated grips 230 include raised elements (e.g., ridges) that provide a tactile indication as to where a technician is intended to grip the tool 200. In other examples, the grips 230 may be textured differently (e.g., rough as compared to a surrounding smooth surface) than surrounding portions of the body 205 as an alternative way to signal where a technician's fingers should be placed. In still other examples, the body 205 may include no tactile distinctions but may include different colors in the locations where a technician is intended to grip the tool 200.

In alternate examples, a grip 230 may be included proximate to only one of the ends 210, 215 or the tool 200 may not include a grip 230.

As illustrated in FIGS. 7 to 10, a pair of guides 235 may extend from an inner surface of the body 205 toward one another. The guides 235 may be disposed proximate to the grips 230 (e.g., on an opposite surface as the respective grip 230). The guides 235 may have a substantially triangular shape, although one or more of the guides 235 may include a different shape.

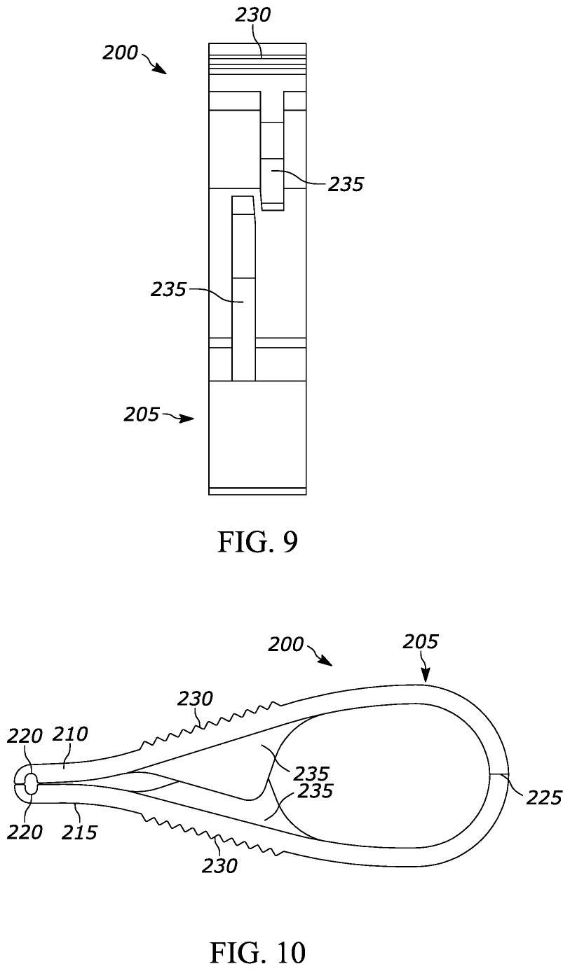

As illustrated in FIG. 9, the guides 235 may be offset from one another so that the guides 235 can pass by one another without contacting each other or without substantially contacting one another. Specifically, the guides 235 allow movement in the vertical direction (as illustrated in FIG. 9) but limit movement in the horizontal direction. This helps to ensure that the cutouts 220 at the ends 210, 215 remain aligned with one another. This also helps to limit sheer stresses on the tool 200 (e.g., at the hinge 225).

Returning to FIGS. 7 and 8, the tool 200 includes a neutral position that is substantially C-shaped or U-shaped (e.g., these terms may be used interchangeably and may also be referred to as arcuate). For example, the tool 200 may include the pair of free ends 210, 215 that are spaced apart from one another and the body 205 may extend continuously between the first end 210 and the second end 215 (e.g., similar to the shape of the letter “C” or the letter “U”). Additionally, each cutout 220 may be in a facing but spaced apart relationship with the other cutout 220. The guides 235 may partially overlap with one another to establish an initial position for alignment between the first and second ends 210, 215. In other words, an end of one guide 235 may extend more inferior than an end of the other guide 235 (see e.g., FIG. 8).

As shown in FIG. 10, the tool 200 includes a biased position where the first and second ends 210, 215 are moved toward one another. This movement is a pivoting movement that occurs about the hinge 225. Specifically, a force may be applied proximate to the grips 230 to create the pivoting movement in the hinge 225. During the movement first and second ends 210, 215, the guides 235 may move past one another without substantially contacting one another (e.g., the spacing between the guides 235 may be maintained). This helps to create substantially unrestricted movement of the first and second ends 210, 215 in one direction (e.g., the vertical direction) while limiting potential movement in another direction (e.g., the horizontal direction).

Once in the biased position, the first and second ends 210, 215 are in contact with one another and the cutouts 220 form a substantially enclosed perimeter. For example, when viewed from the side, the cutouts 220 may combine to form a circular or elliptical shape (although other shapes, like rectangles, may be formed depending on the shape of the cutouts 220).

When a force is removed from the tool 200 (e.g., the technician no longer applies pressure at the grips 230), the tool 200 returns to its neutral position (see e.g., FIG. 8).

As shown in FIGS. 7 to 10, orientation may not matter in some forms of the tool 200. In other words, the first end 210 does not need to be more superior than the second end 215. A technician could use the tool 200 with the second end 215 superior to the first end 210 without effecting the performance of the tool 200. Aside from the offset of the guides 235, the tool 200 may be symmetric.

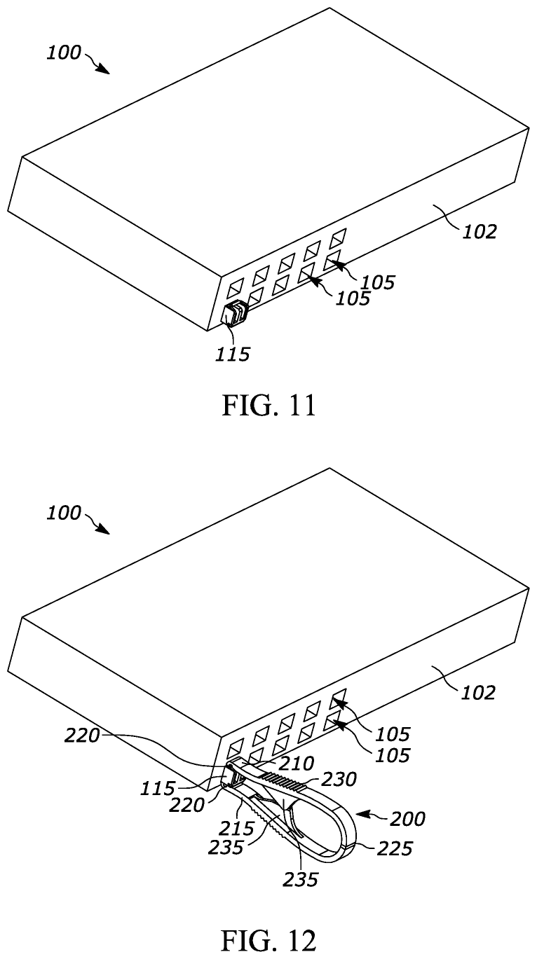

In use, the tool 200 is used to remove a transceiver 115 from a control panel 100. FIG. 11 illustrates a transceiver 115 inserted into one of the receptacles 105. Typically, transceivers 115 connected to cables 110 would be received in the other receptacles, but they have been removed for the purposes of clarity. A cable 110 has previously been disconnected from the transceiver 115 so that the latch 130 is exposed outside of the respective receptacle 105.

As shown in FIG. 12, the tool 200 maybe used to grasp the transceiver 115 while it is received within the receptacle 105. The distance between the first and second ends 210, 215 of the tool 200 may be approximately the height of the transceiver 115. This may allow the first and second ends 210, 215 to fit around the transceiver 115 while in the neutral position.

In some forms, the width of the tool 200 may be less than or equal to the width of the transceiver 115. Specifically, the width of the first end 210 and the width of the second end 215 may each be less than or equal to the width of the transceiver 115. This may assist the technician in maneuvering the tool 200 when other cables 110 and transceivers 115 are connected to the control panel 100. In other words, narrower first and second ends 210, 215 may be more maneuverable through other cables 110 than wider first and second ends 210, 215.

When the tool 200 grasps the transceiver 115, one of the cutouts 220 (e.g., the cutout 220 at the first end 210) may be disposed proximate to the central portion 140 and the sleeve 145 of the latch 130. The technician may orient the tool 200 so that the cutout 220 receives the central portion 140 (and the sleeve 145). As described above, the cutout 220 is shaped to substantially correspond to the shape of the central portion 140. The similar widths of the sleeve 145 and the cutout may allow the central portion 140 to fit snuggly within the cutout 220 (e.g., to limit relative movement between the central portion 140 and the first end 210).

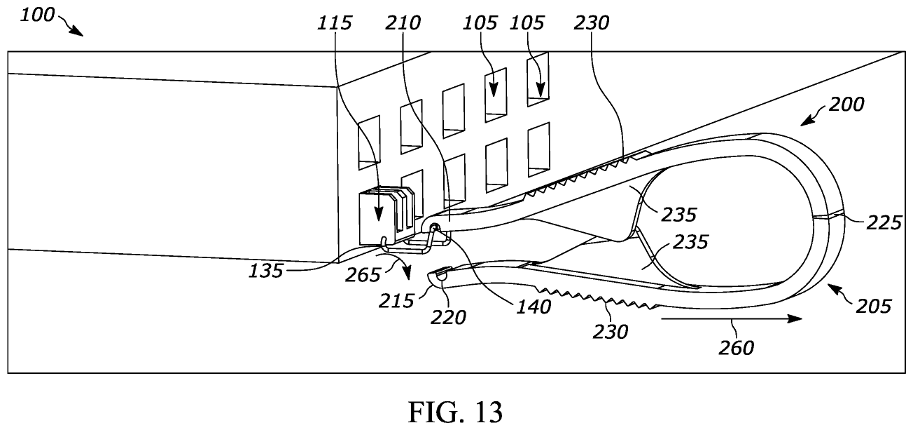

As shown in FIG. 13, the technician may pull the tool 200 away from the control panel 100. The technician may also apply a force to the tool 200 proximate to the grips 230 to move the tool 200 toward the biased position. As the technician pulls the tool 200, the latch 130 may move from the locked position to the unlocked position. This may specifically occur because of the connection between the cutout 220 in the first end 210 and the central portion 140 (e.g., via the sleeve 145). In other words, the undercut shape of the cutout 220 grasps the central portion 140 so that the central portion 140 is at least partially retained within the cutout 220 while the tool 200 moves. Because the cutout 220 and the central portion 140 have substantially the same width, the central portion 140 may be less likely to slip out while the tool 200 is moving.

As the pulling force 260 is applied to the tool 200, the latch 130 initially pivots 265 and the transceiver 115 remains stationary within the receptacle 105. The illustrated latch 130 is intended to move rotationally (e.g., without a substantial translational component) and the transceiver 115 is substantially limited from translating until the latch 130 moves into the unlocked position.

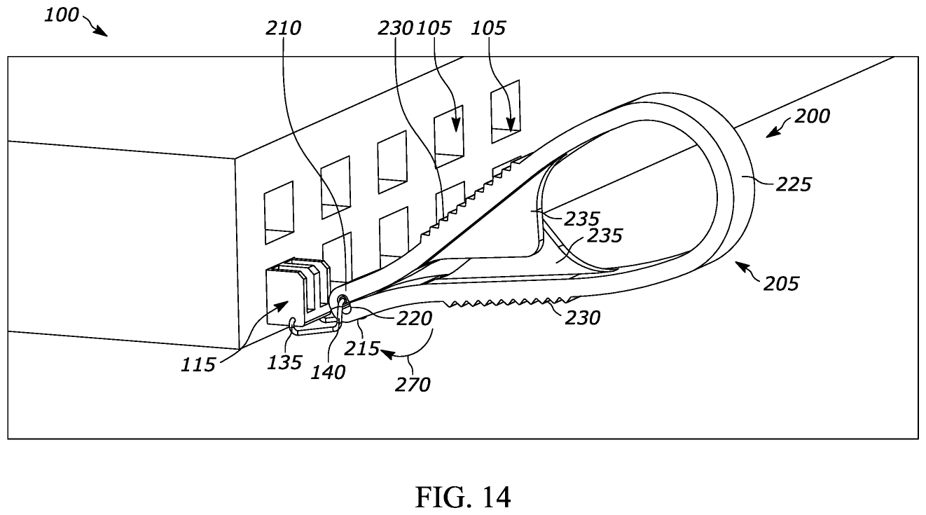

As shown in FIG. 14, the technician may continue to apply a force to the tool 200 (e.g., via the grips 230) so that the tool 200 moves into the biased position (e.g., the second end 215 pivots 270 toward the first end 210). In this position, the first and second ends 210, 215 of the tool 200 may move into substantial contact with one another so that the cutouts 220 are brought together. The guides 230 assist in maintaining that as the tool 200 moves into the biased position, the cutouts 220 remain aligned with one another (e.g., in the vertical direction). The cutouts 220 at the first and second ends 210, 215 may have substantially the same shape so that the enclosed perimeter formed by the cutouts 220 captures the central portion 140. The enclosed perimeter formed by the cutouts 220 may substantially correspond to the shape of the central portion 140 to limit relative movement between the central portion 140 and the tool 200. For example, the diameter of the combined cutouts 220 may be substantially the same as the width of the central portion 140 to limit movement of the central portion 140 while captured within the cutouts 220.

In certain forms, the cutouts 220 may not snap fit, press fit, or friction fit onto the central portion 140 in order to facilitate easier removal of the tool 200 from the transceiver 115.

As the technician continues to apply a force to the grips 230, the first and second ends 210, 215 remain positioned together so that the central portion 140 continues to be captured between the cutouts 220.

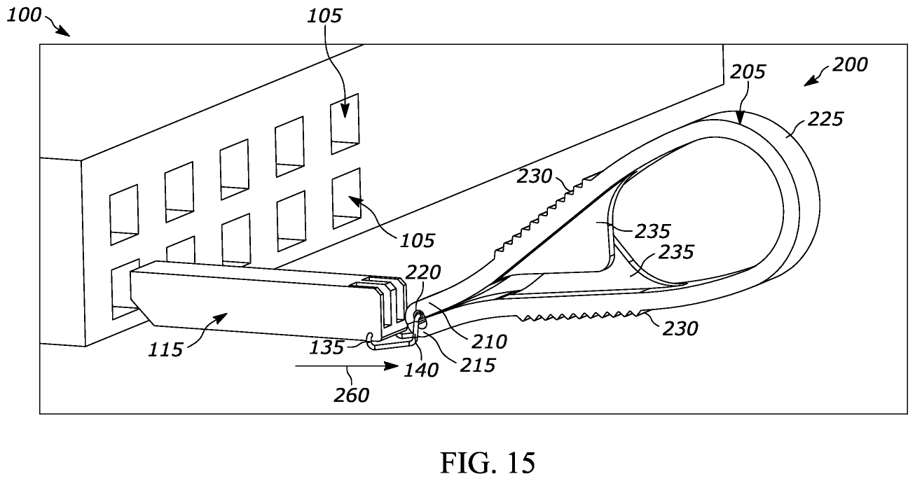

As illustrated in FIG. 15, the technician may pull 260 the on the tool 200 to remove the transceiver 115 from the receptacle 105. As this pulling force is applied, the technician may continue to apply pressure to the grips 230 to maintain the tool 200 in the biased position. Because the tool 200 remains in the biased position, the tool 200 continues to capture the central portion 140, which helps to prevent the technician from dropping and damaging the transceiver 115. The cutouts 220 make this easier than a tool without undercuts (e.g., standard plyers) that do not fully capture the central portion 140 and allow for relative movement between the central portion 140 and the first and second ends 210, 215. For example, the flat, elongated shape of regular plyers allows for relative movement of a rounded central portion, causing slipping between the surfaces as a technician applies a force and attempts to grab the transceiver 115. Capturing the central portion 140 using the tool 200 reduces or eliminates this issue.

Pulling the transceiver 115 by the central portion 140 may permit the body 205 to pivot about the end portions 135 as it exits the receptacle 105. However, the body 205 may be substantially prevented from falling to the ground, unlike in standard plyers, because of the cutouts 220 capturing the central portion 140. The technician can move the transceiver 115 away from the control panel 100 and the other cables 110 to inspect the transceiver 115.

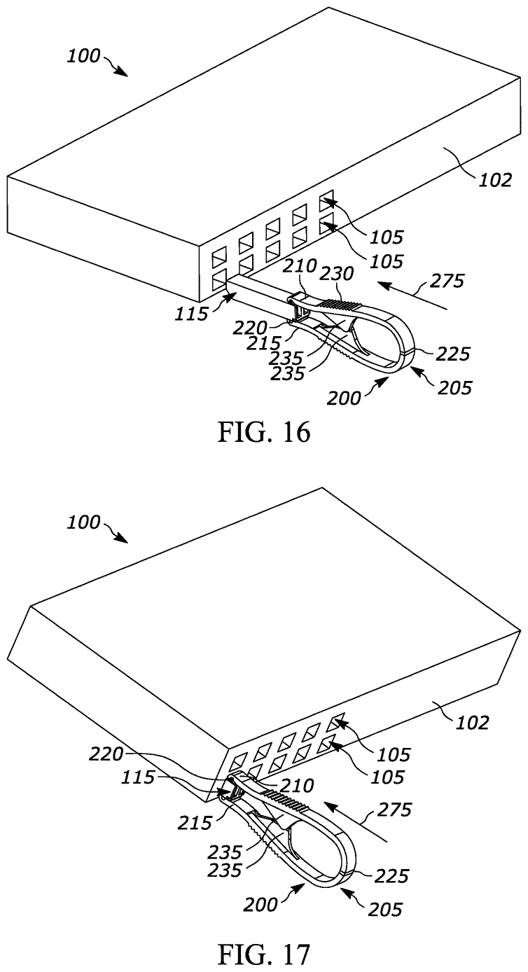

The technician may similarly use the tool 200 to insert a transceiver 115 into an open receptacle 105. As shown in FIG. 16, the technician may orient the tool 200 so that the first end 210 and the second end 215 are positioned on either side of the transceiver 115. This may be similar to the position described in FIG. 12 used as an initial step to remove the transceiver 115 from the receptacle 105.

When the transceiver 115 is being inserted (or reinserted) into a receptacle 105, the latch 130 may begin in the locked position. In other words, the transceiver 115 can be inserted into the receptacle 115 in either the locked or unlocked position. If inserted in the locked position, the transceiver 115 may immediately lock within the receptacle 105 once inserted. If inserted into the unlocked position, the technician may need to move the latch 130 to the locked position to lock the transceiver 115 within the receptacle 105. It may be easier for the technician to move the latch 130 to the locked position when the transceiver 115 is outside of the receptacle 105 to avoid interference from the surrounding cables 110.

In 1 the insertion position illustrated in FIG. 16, the cutout 220 on the first end 210 (or the second end 215 if the tool 200 is reversed) may be positioned to at least partially enclose the central portion 140. For example, the technician may move the latch 130 to the locked position and then position the tool 200 so that the cutout 220 on the first end 210 partially encloses the central portion 140. This may enable the tool 200 to better grip the transceiver 115 during the insertion process. When aligned with the desired receptacle 105, the technician may begin inserting 275 the transceiver 115 into the receptacle 105.

As shown in FIG. 17, the tool 200 may move the transceiver 115 into one of the open receptacles 105 in the control panel 100. The tool 200 may maneuver the transceiver 115 through the other cables 110 (not shown) extending from the control panel 100. Once the transceiver 115 is inserted, the technician may release any force applied to the tool 200 (e.g., at the grips 230) so that the hinge 225 returns the first and second ends 210, 215 to the neutral position. The cutout 220 on the first end 210 may separate from the central portion 140 so that the tool 200 can be removed.

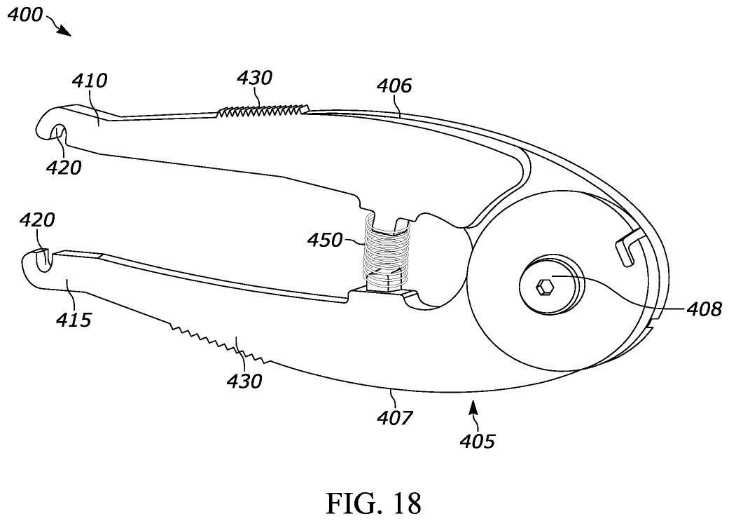

FIG. 18 illustrates an alternate example of a tool 400 from the tool 200 described above. The tool 400 of FIG. 18 is related to the tool 200 and only some similarities and differences are described. Parts that similar to those in tool 200 are labeled with the same reference number plus “200”.

The tool 400 may include a body 405 with a first end 410 and a second end 415 that together make up a working end of the tool 400. The body 405 may be formed as separate pieces with one piece 406 (e.g., a first piece) having the first end 410 and the other piece 407 (e.g., a second piece) having the second end 415. The first and second pieces 406, 407 may be connected to one another using a fastener 408. However, in other examples, the body 405 may be formed as a one-piece construction.

In the illustrated example, the first end 410 and the second end 415 each include a cutout 420 on an inner surface of the body 405 (e.g., an undercut) so that both cutouts are arranged in a facing relationship with one another. The cutouts 420 may have substantially the same shape as the cutouts 220.

The fastener 408 may act as a hinge and permit the first piece 406 and the second piece 407 to rotate. In other words, rotation may occur about the fastener 408. As will be described in more detail below, pressure can be applied to the body 405 to produce a pivoting motion so that the spacing between the first and second ends 410, 415 changes.

In the illustrated example, the first piece 406 and the second piece 407 may be freely rotatable relative to one another. In other words, the first and second pieces 406, 407 on their own may not be biased in any direction. To create bias, a biasing member 450 may be connected between the first and second pieces 406, 407. The biasing member 450 is illustrated as a helical spring, although other types of biasing members (e.g., a conical spring, a torsion spring, etc.) may similarly be used. The spring 450 may compress as the first and second pieces 406, 407 move toward the closed position, and may provide a spring force to return the first and second pieces 406, 407 to the neutral position when the force is removed.

The body 405 may also include at least one grip 430 (e.g., a pair of grips 430 are shown). The grips 430 may be disposed between one of the respective ends 410, 415 and the fastener 408 on an outer surface of the body 405. The illustrated grips 430 include raised elements (e.g., ridges) that provide a tactile indication as to where a technician is intended to grip the tool 400. In other examples, the grips 430 may be textured differently (e.g., rough as compared to a surrounding smooth surface) as an alternative way to signal where a technician's fingers should be placed.

In the illustrated example, the tool 400 may not include guides like the tool 200. Instead, the spring 450 may act partially as a guide and for movement of the first and second pieces 406, 407. In other examples, the tool 400 may include guides similar to the guides in the tool 200.

Like the tool 200, the tool 400 includes a neutral and biased position. As described above, pressure may be applied to the first and second pieces 406, 407 to exceed the spring force and move the first and second ends 410, 415 toward one another. When the pressure is removed, the spring force returns the first and second pieces 406, 407 to the neutral position (e.g., with the first and second ends 410, 415 spaced apart like in FIG. 18).

The tool 400 may be used to insert and/or remove the transceiver 115 from the receptacle 105 of the control panel 100 just like the tool 200.

One of ordinary skill will appreciate that the exact dimensions and materials are not critical to the disclosure and all suitable variations should be deemed to be within the scope of the disclosure if deemed suitable for carrying out the objects of the disclosure.

One of ordinary skill in the art will also readily appreciate that it is well within the ability of the ordinarily skilled artisan to modify one or more of the constituent parts for carrying out the various examples of the disclosure. Once armed with the present specification, routine experimentation is all that is needed to determine adjustments and modifications that will carry out the present disclosure.

The above examples are for illustrative purposes and are not intended to limit the scope of the disclosure or the adaptation of the features described herein. Those skilled in the art will also appreciate that various adaptations and modifications of the above-described preferred examples can be configured without departing from the scope and spirit of the disclosure. Therefore, it is to be understood that, within the scope of the appended claims, the disclosure may be practiced other than as specifically described.

What is claimed is:

1. A tool for facilitating the insertion or removal of a transceiver relative to a control panel, the tool comprising:
a U-shaped body having an integral one-piece construction, the body comprising,
a first end having a first rounded undercut disposed on an inner surface of the body,
a second end having a second rounded undercut disposed on the inner surface of the body and arranged facing the first undercut,
a hinge portion disposed between the first end and the second end,
a first guide portion disposed on the inner surface of the body between the first end and the hinge portion, and
a second guide portion disposed on the inner surface of the body between the second end and the hinge portion, wherein the second guide is offset from the first guide;
wherein the body is configured to move in a first direction about the hinge portion between a neutral position where the first and second ends are spaced apart from one another and a biased position where the first and second ends are in contact with one another;
wherein the first guide portion and the second guide portion are configured to limit movement in a second direction about the hinge portion that is perpendicular to the first direction; and
wherein in the biased position, the first rounded undercut and the second rounded undercut form an enclosed perimeter configured to capture and secure at least a portion of the transceiver.

2. The tool of claim 1, wherein the body is formed via a molded plastic part.

3. The tool of claim wherein the first rounded undercut and the second rounded undercut each include a semi-circular or semi-elliptical cross section.

4. The tool of claim 1, wherein the body further comprises a first grip disposed on an outer surface of the body opposite to the first guide portion and a second grip disposed on the outer surface of the body opposite to the second guide portion.

5. The tool of claim wherein the body is 180° compatible and can be used with either the first end being superior to the second end or the second end being superior to the first end.

6. The tool of claim 1, wherein:
the body is formed via a molded plastic part;
the first rounded undercut extends the entire width of the first end and includes a semi-circular or semi-elliptical cross section;
the second rounded undercut extends the entire width of the second end and includes a semi-circular or semi-elliptical cross section;
a first grip is disposed on an outer surface of the body opposite to the first guide portion and is closer to the first end than to the hinge, wherein the first grip includes a first series of ridges; and
a second grip is disposed on an outer surface of the body opposite to the second guide portion and is closer to the second end than to the hinge, wherein the second grip includes a second series of ridges.

7.-11. (canceled)

12. A method of removing a transceiver from a control panel, the method comprising:
removing a cable from a first end of a transceiver received within a receptacle of the control panel, the first end including a latch;
positioning a tool at least partially around the latch, the tool comprising:
a U-shaped body comprising,
a first end having a first undercut disposed on an inner surface of the body,
a second end,
a hinge portion disposed between the first end and the second end, and
applying a force to the body to move the body from a neutral position toward a biased position, wherein a spacing between the first end and the second end is less in the biased position than in the neutral position;
partially surrounding a portion of the latch with the first undercut;
pulling the tool to move the latch from a locked position to an unlocked position, wherein the portion of the latch remains partially surrounded by the first undercut; and
applying an additional force to move the second end into contact with the first end, wherein the first undercut and the second undercut forming an enclosed perimeter to capture the portion of the latch.

13. The method of claim 12, wherein the width of the first end and the width of the second end is less than a width of the transceiver.

14. The method of claim 12, wherein body is formed as an integral one-piece construction via a molded plastic part.

15. The method of claim 12, wherein:
the first end is included on a first piece and the second end is included on a second piece separable from the first piece;
the hinge includes a fastener that connects the first piece to the second piece and is configured to allow relative rotation between the first piece and the second piece;
the first undercut includes a substantially semi-circular or semi-elliptical cross section;
the second end includes a second undercut that has a substantially semi-circular or semi-elliptical cross section;
a biasing member is positioned between the first piece and the second piece and configured to bias the first piece and the second piece toward the neutral position; and
applying the force to the body overcomes a spring force in the biasing member.

16. The method of claim 12, wherein:
the first undercut extends the entire width of the first end and includes a semi-circular or semi-elliptical cross section;
the second includes a second undercut that extends the entire width of the second end and includes a semi-circular or semi-elliptical cross section.

17. The method of claim 12, wherein the body is 180° compatible and can be used with either the first end being superior to the second end or the second end being superior to the first end.

18. The method of claim 12, wherein:
a first guide portion is disposed on the inner surface of the body between the first end and the hinge portion, and
a second guide portion disposed on the inner surface of the body between the second end and the hinge portion, wherein the second guide is offset from the first guide; and
the first guide portion and the second guide portion are configured to limit movement in a direction about the hinge portion that is perpendicular to a direction of movement between the neutral position and the biased position.

19. The method of claim 12, wherein the body further comprises a first grip disposed on an outer surface of the body opposite to the first guide portion and a second grip disposed on the outer surface of the body opposite to the second guide portion, and wherein applying the force to the body occurs at the first grip and the second grip.

20. The method of claim 12 wherein the portion of the latch includes a substantially cylindrical shape that corresponds to the shape of the enclosed perimeter of the first undercut and the second undercut.

21.-25 (canceled)

26. A method of inserting a transceiver from a control panel, the method comprising:
moving a latch at a first end of the transceiver to a locked position;
positioning a tool at least partially around the latch, the tool comprising:
a U-shaped body comprising,
a first end having a first undercut disposed on an inner surface of the body,
a second end,
a hinge portion disposed between the first end and the second end, and
applying a force to the body to move the body from a neutral position toward a biased position, wherein a spacing between the first end and the second end is less in the biased position than in the neutral position;
partially surrounding a portion of the latch with the first undercut; and
pushing the tool to move the transceiver into a receptacle of the control panel.

27. The method of claim 26, wherein the width of the first end and the width of the second end is less than a width of the transceiver.

28. The method of claim 26, wherein body is formed as an integral one-piece construction via a molded plastic part.

29. The method of claim 26, wherein:
the first undercut extends the entire width of the first end and includes a semi-circular or semi-elliptical cross section;
the second includes a second undercut that extends the entire width of the second end and includes a semi-circular or semi-elliptical cross section.

30. The method of claim 26, wherein:
a first guide portion is disposed on the inner surface of the body between the first end and the hinge portion, and
a second guide portion disposed on the inner surface of the body between the second end and the hinge portion, wherein the second guide is offset from the first guide; and
the first guide portion and the second guide portion are configured to limit movement in a direction about the hinge portion that is perpendicular to a direction of movement between the neutral position and the biased position.
